(19) United States
(12) Patent Application Publication
(10) Pub. No.: US 2022/0252748 A1
(43) Pub. Date: Aug. 11, 2022

(54) SEISMIC SENSOR AND METHODS RELATED THERETO

(71) Applicants: Rosneft Oil Company, Moscow (RU); BP Exploration Operating Company Limited, Middlesex (GB)

(72) Inventor: Mathias CONTANT, Sandvika (NO)

(73) Assignees: Rosneft Oil Company, Moscow (RU); BP Exploration Operating Company Limited, Middlesex (GB)

(21) Appl. No.: 17/614,283

(22) PCT Filed: May 28, 2019
(86) PCT No.: PCT/RU2019/000371

§ 371 Date: Nov. 24, 2021

(51) Int. Cl. G01V 1/18; G01V 1/16

(52) U.S. Cl. CPC G01V 1/181; G01V 2210/1425; G01V 1/164

(57) ABSTRACT

Example seismic sensors and methods relating thereto are disclosed. In an embodiment, the seismic sensor includes an outer housing and a proof mass disposed in the inner cavity of the outer housing. In addition, the seismic sensor includes a first biasing member positioned in the inner cavity between the proof mass and an outer housing upper end that is configured to flex in response to axial movement of the outer housing relative to the proof mass. Further, the seismic sensor includes a second biasing member positioned in the inner cavity between the first biasing member and the outer housing upper end. Still further, the seismic sensor includes a sensor element positioned in the inner cavity between the proof mass and an outer housing lower end that is configured to generate a potential in response to movement of the outer housing relative to the proof mass.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Seismic surveying, or reflection seismology, is used to map the Earth's subsurface. During a seismic survey, a controlled seismic source emits low frequency seismic waves that travel through the subsurface of the Earth. At interfaces between dissimilar rock layers, the seismic waves are partially reflected. The reflected waves return to the surface where they are detected by one or more seismic sensors. In particular, the seismic sensors detect and measure vibrations induced by the waves. Ground vibrations detected by the seismic sensors at the earth surface can have a very wide dynamic range, with displacement distances ranging from centimeters to angstroms. Data recorded by the seismic sensors is analyzed to reveal the structure and composition of the subsurface.

### BRIEF SUMMARY

Some embodiments disclosed herein are directed to a seismic sensor. In an embodiment, the seismic sensor includes an outer housing having a central axis, an upper end, a lower end, and an inner cavity. In addition, the seismic sensor includes a proof mass moveably disposed in the inner cavity. The outer housing is configured to move axially relative to the proof mass. Further, the seismic sensor includes a first biasing member disposed in the inner cavity and axially positioned between the proof mass and the upper end of the outer housing. The first biasing member is configured to flex in response to axial movement of the outer housing relative to the proof mass, and the first biasing member comprises a disc including a plurality of circumferentially-spaced slots extending axially therethrough and an axially extending recess. Still further, the seismic sensor includes a second biasing member disposed in the inner cavity and axially positioned between the first biasing member and the upper end of the outer housing. The second biasing member includes a projection that is configured to engage with the recess of the first biasing member. Also, the seismic sensor includes a sensor element disposed in the inner cavity and axially positioned between the proof mass and the lower end of the outer housing. The sensor element comprises a piezoelectric material configured to deflect and generate a potential in response to the axial movement of the outer housing relative to the proof mass and the flexing of the first biasing member and the second biasing member.

In another embodiment, the seismic sensor includes an outer housing having a central axis, a first end, a second end opposite the first end, and an inner cavity, and a proof mass moveably disposed in the inner cavity. The proof mass comprises a power supply. In addition, the seismic sensor includes a disc-shaped sensor element disposed in the inner cavity and positioned axially between the proof mass and the second end. The sensor element is configured to detect the movement of the outer housing relative to the proof mass. Further, the seismic sensor includes electronic circuitry coupled to the sensor element, a first resilient disc disposed in the inner cavity and axially positioned between the first end of the outer housing and the proof mass, and a second resilient disc disposed in the inner cavity and axially positioned between the proof mass and the sensor element. The first resilient disc and the second resilient disc each comprise a central region coupled to the proof mass and a radially outer periphery fixably coupled to the outer housing. The first resilient disc and the second resilient disc each include a plurality of circumferentially-spaced slots extending axially therethrough. The first resilient disc includes an axially extending recess. Still further, the seismic sensor includes a biasing member disposed in the inner cavity and axially positioned between the first resilient disc and the first end of the outer housing.

Other embodiments disclosed herein are directed to a method for detecting seismic waves passing through a subterranean formation. In an embodiment, the method includes (a) coupling a seismic survey apparatus to the ground above the subterranean formation. The seismic survey apparatus includes an outer housing having a longitudinal axis, an upper end, a lower end, and an inner cavity, a proof mass moveably disposed in the inner cavity, and a sensor element disposed in the inner cavity and axially positioned between the proof mass and the lower end of the outer housing. In addition, the seismic survey apparatus includes a sensor element disposed in the inner cavity and axially positioned between the proof mass and the lower end of the outer housing, and a first resilient disc disposed in the inner cavity and axially positioned between the first end of the outer housing and the proof mass. Further, the seismic survey apparatus includes a second resilient disc disposed in the inner cavity and axially positioned between the proof mass and the sensor element, and a biasing member disposed in the inner cavity and axially positioned between the first resilient disc and the upper end of the outer housing. The biasing member includes a projection that is received within an axially extending recess of the first resilient disc. In addition, the method includes (b) orienting the seismic survey apparatus with the longitudinal axis of the housing in a vertical orientation, (c) moving the outer housing vertically relative to the proof mass in response to seismic waves, and (d) axially flexing the first resilient disc, the second resilient disc, and the biasing member in response to (c). Further, the method includes (e) axially deflecting the sensor element during (c) and (d), and (f) generating a signal with the sensor element indicative of the vertical movement of the outer housing relative to the proof mass during (c) in response to (e).

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic representation of a seismic surveying system for surveying a subsurface earthen formation according to some embodiments;

FIG. 2 is a perspective view of an embodiment of a seismic sensor which may be used within the system of FIG. 1 according to some embodiments;

FIG. 3 is a longitudinal cross-sectional view of the seismic sensor of FIG. 2;

FIG. 4 is a perspective view of the battery and tabs of the seismic sensor of FIG. 2;

FIG. 5 is an enlarged, longitudinal cross-sectional view of a portion of the seismic sensor of FIG. 2; and

FIG. 6 is a perspective view of the biasing member of the seismic sensor of FIG. 2.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein including the claims, the word “about,” “generally,” “substantially,” “approximately,” and the like mean within a range of plus or minus 10%.

As previously described, during a seismic survey, seismic sensors are used to detect reflected seismic waves to reveal the structure and composition of the subsurface. One type of seismic sensor relies on capacitance to generate the electrical signal. With one example approach, these sensors can be constructed as Microelectromechanical systems (MEMS) using micro machined silicon with metal plating applied to facing components on opposite sides of a small plated and spring loaded mass. These MEMS sensors often have the advantage of small size and weight compared to a moving coil geophone. The movement of the MEMS proof mass relative to the outer fixed plates creates variable capacitance that is detected as a signal proportional to the acceleration of the sensor displacement. In some circumstances, it is desirable to limit the motion of the proof mass within a given axis or direction during normal operations, while still allowing the proof mass (and/or its support structure within the sensor unit) to accommodate large off-axis impulses or shocks without damage. Accordingly, embodiments disclosed herein include seismic sensors including one or more biasing members that generally allow relative movement between the internal proof mass and outer housing within desired longitudinal axis, but also restrict the relative moment of the proof mass and housing in a lateral direction. In addition, the one or more biasing members may allow some relative movement of the proof mass and housing when a sufficiently large, off-axis (e.g., lateral) shock or impulse is transferred to the seismic sensor. Thus, through use of the seismic sensors disclosed herein, off-axis vibrations may be reduced during normal seismic survey operations so that the resulting seismic measurements may have less noise; however, damage to internal components of the seismic sensor as a result of large off-axis impulses may also be reduced or eliminated entirely.

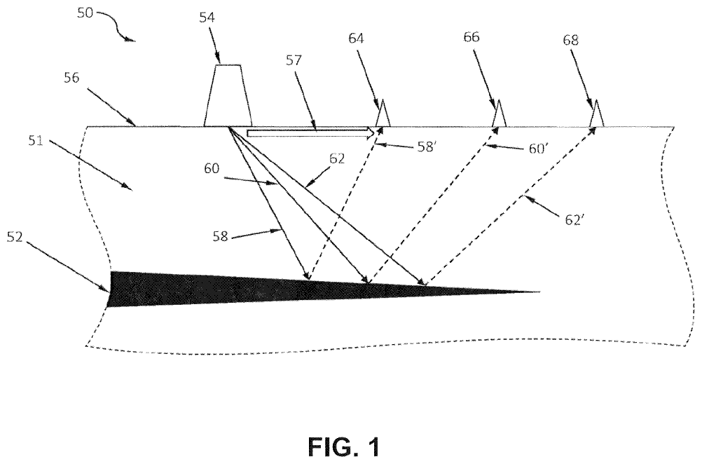

Referring now to FIG. 1, a schematic representation of a seismic surveying system 50 for surveying a subsurface earthen formation 51 is shown. As shown in FIG. 1, the subsurface 51 has a relatively uniform composition with the exception of layer 52, which may be, for example, a different type of rock as compared to the remainder of subsurface 51. As a result, layer 52 may have a different density, elastic velocity, etc. as compared to the remainder of subsurface 51.

Surveying system 50 includes a seismic source 54 disposed on the surface 56 of the earth and a plurality of seismic sensors 64, 66, 68 firmly coupled to the surface 56. The seismic source 54 generates and outputs controlled seismic waves 58, 60, 62 that are directed downward into the subsurface 51 and propagate through the subsurface 51. In general, seismic source 54 can be any suitable seismic source including, without limitation, explosive seismic sources, vibroseis trucks and accelerated weight drop systems also known as thumper trucks. For example, a thumper truck may strike the surface 56 of the earth with a weight or “hammer” creating a shock which propagates through the subsurface 51 as seismic waves.

Due to the differences in the density and/or elastic velocity of layer 52 as compared to the remainder of subsurface 51, the seismic waves 58, 60, 62 are reflected, at least partially, from the surface of the layer 52. The reflected seismic waves 58′, 60′, 62′ propagate upwards from layer 52 to the surface 56 where they are detected by seismic sensors 64, 66, 68.

The seismic source 54 may also induce surface interface waves 57 that generally travel along the surface 56 with relatively slow velocities, and are detected concurrently with the deeper reflected seismic waves 58′, 60′, 62′. The surface interface waves 57 generally have a greater amplitude than the reflected seismic waves 58′, 60′, 62′ due to cumulative effects of energy loss during propagation of the reflected seismic waves 58′, 60′, 62′ such as geometrical spreading of the wave front, interface transmission loss, weak reflection coefficient and travel path absorption. The cumulative effect of these losses may amount to a 75 dB, and in cases more than 100 dB, in amplitude difference between various waveforms recorded by sensors 64, 66, 68.

The sensors 64, 66, 68 detect the various waves 57, 58′, 60′, 62′, and then store and/or transmit data indicative of the detected waves 57, 58′, 60′, 62′. This data can be analyzed to determine information about the composition of the subsurface 51 such as the location of layer 52.

Although seismic surveying system 50 is shown and described as a surface or land-based system, embodiments described herein can also be used in connection with seismic surveys in transition zones (e.g., marsh or bog lands, areas of shallow water such as between land and sea) and marine seismic survey systems in which the subsurface of the earthen formation (e.g., subsurface 51) is covered by a layer of water. In marine-based systems, the seismic sensors (e.g., seismic sensors 64, 66, 68) may be positioned in or on the seabed, or alternatively on or within the water. In addition, in such marine-based systems, alternative types of seismic sources (e.g., seismic sources 54) may be used including, without limitation, air guns and plasma sound sources.

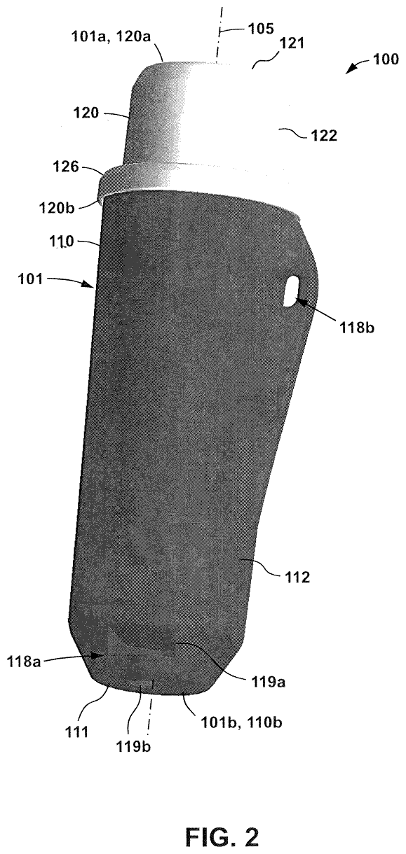

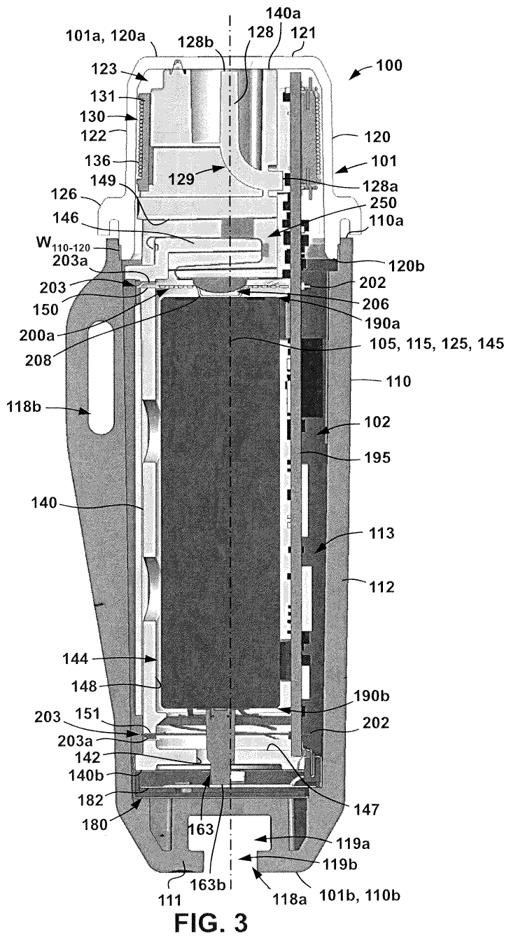

Referring now to FIGS. 2 and 3, an embodiment of a seismic sensor 100 is shown. In general, seismic sensor 100 can be used in any seismic survey system. For example, sensor 100 can be used for any one or more of sensors 64, 66, 68 of seismic surveying system 50 shown in FIG. 1 and described above. Although sensor 100 can be used in land or marine seismic survey systems, it is particularly suited to land-based seismic surveys. Generally speaking, seismic sensor 100 may include many similar components to those discussed in U.S. Pat. No. 10,139,506, filed Mar. 12, 2015, which is hereby incorporated by reference in its entirety for all purposes.

Referring to FIG. 3, in one or more embodiments, seismic sensor 100 includes an outer housing 101, an inductive spool assembly 130 disposed within housing 101, a carrier 140 disposed in housing 101, and a sensor assembly 180 disposed within housing 101 and coupled to carrier 140. Housing 101 has a central or longitudinal axis 105, a first or upper end 101a, a second or lower end 101b, and an inner chamber or cavity 102. Ends 101a, 101b are closed and inner cavity 102 is sealed and isolated from the environment surrounding sensor 100, thereby protecting the sensitive components disposed within housing 101 from the environment (e.g., water, dirt, etc.). In addition, housing 101 includes a generally cup-shaped body 110 and an inverted cup-shaped cap 120 fixably attached to body 110.

Body 110 has a central or longitudinal axis 115 that is coaxially aligned with axis 105, a first or upper end 110a, and a second or lower end 110b defining lower end 101b of housing 101. In addition, body 110 includes a base 111 at lower end 110b and a tubular sleeve 112 extending axially upward from base 111 to upper end 110a. Base 111 closes sleeve 112 at lower end 110b; however, sleeve 112 and body 110 are open at upper end 110a. As a result, body 110 includes a receptacle 113 extending axially from upper end 110a to base 111. Receptacle 113 forms part of inner cavity 102 of housing 101.

In this embodiment, body 110 of outer housing 101 includes a pair of connectors 118a, 118b. Connector 118a is provided on base 111 and connector 118b is provided along sleeve 112. Connector 118a includes rectangular throughbore 119a extending radially therethrough and a hole 119b extending axially from lower end 110b to throughbore 119a. Hole 119b is internally threaded and threadably receives the externally threaded end of a spike (not shown) used to secure sensor 100 to the ground during seismic survey operations. Throughbore 119a enables a rope or the like (not shown) to be attached to sensor 100 for deployment, for example. In particular, the rope may be folded double and inserted throughbore 119a. Thus, bore 119a has a width of at least twice the diameter of the rope. The loop formed by the portion of folded rope extending through bore 119a is then placed around the sensor 100. In this manner, a plurality of sensors 100 can be coupled to a single rope without side ropes, hooks or other mechanisms that can complicate the handling of multiple sensors 100.

The connector 118b is disposed along the outside of sleeve 112 proximal upper end 101a. In general, connector 118b provides an alternative connection point for handling of sensor 100 during deployment and retrieval. In this embodiment, connector 1218b is an eye connector or throughbore to which a rope, lanyard, hook, carabiner or the like can be releasably attached. Connector 118b can also be used in a manner similar to throughbore 119a, thereby allowing a rope to be folded double and inserted through the hole of connector 118b. Thus, the bore of connector 118a has a width of at least twice the diameter of the rope. The loop formed by the portion of folded rope extending through the bore of connector 118b is then placed around the sensor 100. In this manner, a plurality of sensors 100 can be coupled to a single rope without side ropes, hooks or other mechanisms that can complicate the handling of multiple sensors. In this embodiment, the entire body 110 (including base 111 and sleeve 112) is made via injection molding.

Referring still to FIGS. 2 and 3, cap 120 has a central or longitudinal axis 125 that is coaxially aligned with axis 105, a first or upper end 120a defining upper end 101a of housing 101, and a second or lower end 120b. In this embodiment, cap 120 has the general shape of an inverted cup. In particular, cap 120 includes a planar cylindrical top 121 at upper end 120a and a tubular sleeve 122 extending axially downward from top 121 to lower end 120b. Top 121 closes sleeve 122 at upper end 120a; however, sleeve 122 and cap 120 are open at lower end 120b. As a result, cap 120 includes an inner chamber or cavity 123 extending axially from lower end 120b to top 121. An annular flange 126 extends radially outward from sleeve 122 proximal lower end 120b.

Cap 120 is fixably attached to body 110 such that cap 120 is coaxially aligned with body 110 with lower end 120b of cap 120 seated within upper end 110a of body 110 and upper end 110a of body 110 coupled to flange 126. Body 110 and cap 120 are sized such that an interference fit is provided between lower end 120b of cap 120 and upper end 110a of body 110. In this embodiment, body 110 and cap 120 are made of the same material (polycarbonate), and thus, are can be ultrasonically welded together to fixably secure cap 120 to body 110. More specifically, as shown in FIG. 3 an annular ultrasonic weld W₁₁₀₋₁₂₀ is formed between the opposed radially outer surface and radially inner surface of sleeves 122, 112, respectively, at ends 120b, 110a. Weld W₁₁₀₋₁₂₀ defines an annular seal between cap 120 and body 110 that prevents (or at least restricts) fluid communication between cavities 113, 123 and the environment surrounding sensor 100.

Referring still to FIGS. 2 and 3, a power source or supply 190 and electronic circuitry 195 are removably mounted to carrier 140 within housing 101, particularly within cavity 113 of body 110. In this embodiment, power supply 190 is a battery and electronic circuitry 195 is in the form of a circuit board (e.g., PCB). Thus, power supply 190 may also be referred to as battery 190 and electronic circuitry 195 may also be referred to as circuit board 195. Electronic circuitry 195 is fixably mounted to carrier 140 within housing 101. In addition, a battery 190 is movably disposed within housing 101 such that battery 190 is configured to move axially relative to housing 101 (with respect to axis 105 described below), carrier 140, and circuitry 195 during operations. Generally speaking, battery 190 includes a first or upper end 190a and a second or lower end 190b, opposite upper end 190a. When battery 190 is inserted within cavity 102 of housing 101, upper end 190a of battery 190 is more proximate upper end 101a than lower end 101b and lower end 190b of battery 190 is more proximate lower end 101b than upper end 101a.

Sensor assembly 180 includes a sensor element 182 that comprises flat disc seated within housing 101, particularly within cavity 113 of body 110 proximate base 111. In this embodiment, sensor element 182 is a flat disc comprising one or more layers of a rigid piezoelectric ceramic material. More particularly, sensor element 182 may comprise a substrate on which the piezoelectric ceramic material is supported. In some embodiments, the piezoelectric ceramic material comprises lead zirconate titanate (PZT) which is regarded as low cost and relatively strong. The substrate may be electrically conductive and may comprise beryllium copper or brass in some embodiments. The one or more layers of piezoelectric ceramic material may be bonded to (and potentially disposed between) one or more layers of the substrate to provide a substantially flat member. During operations, the sensor element 182 may have a sufficient elastic compliance so as to support the proof mass of sensor 100 without fracturing. In addition, the sensor element 182 (including the one or more layers of piezoelectric ceramic material and substrate) may have a bending stiffness which is greater than the piezoelectric ceramic material alone. In some embodiments, the sensitivity and resonance peak frequency of the sensor element 182 may be set based on various factors (e.g., the diameter and thickness of sensor element 182—particularly of the piezoelectric ceramic material, the ratio of Titanium to zirconium in the piezoelectric ceramic material, etc.).

When mechanical stress is applied to sensor element 182 due to deformation or deflection, the piezoelectric ceramic material generates an electrical potential (piezoelectric effect). In some circumstances, a change in the surrounding electromagnetic field may also cause a physical distortion in PZT, and thereby reduce the quality of measurement data captured by sensor element 182. Accordingly, in some embodiments, shielding may be disposed about the sensor element 182 to reduce or prevent any influence of the local electromagnetic field on the piezoelectric ceramic materials during operations. Sensor element 182 is electrically coupled to circuit board 195 with wires, pins, or other suitable conductive paths, such that the electrical potential generated by the piezoelectric ceramic material is detected and measured by electronics housed on circuit board 195 and stored in memory on circuit board 195.

Inductive spool assembly 130 is used to inductively charge the battery 190 from the outside of sensor 100 (e.g., wirelessly). In this embodiment, spool assembly 130 is mounted within cavity 123 of cap 120 and includes a cylindrical sleeve-shaped body 131 and a coil 136 wound around body 131. Coil 136 is electrically coupled to circuit board 195 with wires or other suitable conductive paths (not shown) that enable the transfer of current to circuit board 195, which in turn charges battery 190 during charging operations.

Referring still to FIGS. 2 and 3, in this embodiment, carrier 140 supports circuit board 195 and a light guide 128 within cavity 102 of outer housing 110. In this embodiment, carrier 140, circuit board 195, and light guide 128 are fixably coupled to outer housing 101 and do not move relative to outer housing 110, however, battery 190 is movably coupled to carrier 140, and thus, battery 190 (which may be referred to herein as a “proof mass” for seismic sensor 100) can move axially relative to carrier 140, circuit board 195, light guide 128, and outer housing 101.

Carrier 140 has a central or longitudinal axis 145 coaxially aligned with axis 105, a first or upper end 140a extending through inductive spool assembly 130, and a second or lower end 140b axially adjacent base 111. Carrier 140 has an axial length that is substantially the same as the axial length of cavity 102. Thus, upper end 140a engages top 121 of cap 120 and lower end 140b is seated against sensor assembly 180 which in turn is supported by base 111 of body 110. More specifically, carrier 140 is axially compressed between cap 120 and body 110. As a result, movement of carrier 140 relative to outer housing 101 is generally restricted (or prevented entirely) during operations, so that carrier 140 is fixably secured or mounted within housing 101.

Referring still to FIGS. 2 and 3, carrier 140 includes an axially extending internal recess or pocket 144. Pocket 144 is defined by an upper end surface 149, a lower end surface 147, and a cylindrical surface 148 extending axially between end surfaces 149, 147. Battery 190 is disposed within pocket 144 but does not contact carrier 140. In particular, the dimensions of pocket 144 are greater than the dimensions of battery 190 (e.g., the radius of surface 148 is greater than the outer radius of battery 190, and the axial distance between end surfaces 149, 147 is greater than the length of battery 190 between ends 190a, 190b). In this embodiment, battery 190 is oriented parallel to but is slightly radially offset from aligned axes 105, 145. In particular, the central axis (not shown) of battery 190 is radially offset from axes 105, 145 by about 1.0 to 1.5 mm.

Referring specifically now to FIG. 3, carrier 140 also includes a projection 146 that extends generally radially within pocket 144, and that is axially positioned between upper end 190a of battery 190 and upper surface 149. In addition, carrier 140 includes a first or upper annular recess 150, and second or lower annular recess 151. Upper annular recess 150 extends radially outward from cylindrical surface 148 of pocket 144 within carrier 140 proximate upper end 110a of body 110 but axially below projection 146, and lower annular recess 151 extends radially outward from cylindrical surface 148 of pocket 144 proximate base 111. Further, carrier 140 includes a throughbore 142 extending through lower surface 147 of pocket 144 in a direction that is generally parallel to aligned axes 105, 145.

Referring still to FIG. 3, elongate curved L-shaped light guide 128 is fixably secured to carrier 140 generally axially above pocket 144 within cavity 123 of cap 120. In this embodiment, light guide 128 is integral with and monolithically formed with carrier 140. Light guide 128 is generally “L” shaped, and thus includes a first end 128a, a second end 128b and a 90° curve or corner 129 between ends 128a, 128b. As will be described in more detail below, light guide 128 wirelessly communicates data to/from circuit board 195 through top 121. To facilitate the transmission of light, light guide 128 and top 121 are made of a clear material. In this embodiment, the entire cap 120 (including top 121 and sleeve 122) and guide 128 are made of a clear polycarbonate.

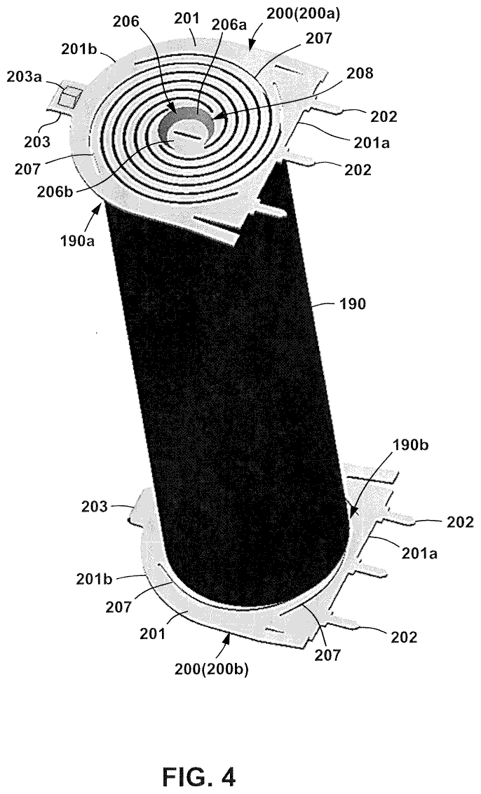

Referring now to FIGS. 3 and 4, battery 190 has a cylindrical shape and is coupled to circuit board 195 with a pair of tabs 200. In particular, tabs 200 are disposed at the ends 190a, 190b of battery 190 and are spring loaded to axially compress battery 190 therebetween (e.g., with respect to aligned axes 105, 145). In this embodiment, tabs 200 are made of metal (e.g., steel, such as spring steel), and provide both a physical and electrical connection between battery 190 and circuit board 195. Thus, tabs 200 enable battery 190 to provide power to circuit board 195 and the various functions performed by the components of board 195 during seismic survey operations, and enable board 195 to provide power to battery 190 during inductive charging operations.

In this embodiment, each tab 200 is a resilient, semi-rigid element through which battery 190 is supported within pocket 144 of carrier 140. As best shown in FIG. 4, each tab 200 comprises a resilient disc 201, a plurality of prongs 202 extending radially from disc 201, and a connector 203 extending radially from disc 201 (e.g., with respect to axis 105 previously described). Connector 203 includes an axially extending raised bump or projection 203a (e.g., axially with respect to axis 105 previously described). As best shown in FIG. 4, disc 201 has a semi-cylindrical shape including a straight edge 201a and a semi-circular edge 201b extending from straight edge 201a. Prongs 202 extend from straight edge 201a and connector 203 extends from semi-circular edge 201b opposite prongs 202.

For purposes of clarity and further explanation, the tab 200 coupled to upper end 190a of battery 190 may be referred to as the upper tab 200a and the tab 200 coupled to lower end 190b of battery 190 may be referred to as the lower tab 200b. Generic references herein to “tabs 200” refer to both the upper tab 200a and lower tab 200b. The semi-circular edge 201b of upper tab 200a is seated in upper recess 150 of carrier 140, and the semi-circular edge 201b of lower tab 200b is seated in lower recess 151 of carrier 140. As best shown in FIG. 3, projection 203a of connector 203 in upper tab 200a is seated within upper recess 150, and projection 203a of connector 203 of lower tab 200b is seated in lower recess 151. The positioning of edges 201b and connectors 203 in recesses 250, 251 maintains the outer periphery of tabs 200 generally static or fixed relative to carrier 140 and outer housing 101. In this embodiment, prongs 202 of tabs 200 extend through circuit board 195 and are soldered thereto.

Referring now to FIGS. 3-5, upper tab 200a includes a central projection 208 and a plurality of uniformly circumferentially-spaced through cuts or slots 207 radially positioned between projection 208 and edges 201a, 201b. Upper tab 200a is oriented such that central projection 208 faces and extends toward upper end 190a of battery 190 in an axial direction (e.g., axially with respect to aligned axes 105, 145). In addition, projection 208 forms or defines a receptacle or recess 206 on an opposing side of upper tab 200a (e.g., a side of upper tab 200a that faces axially away from upper end 190a of battery 190). Projection 208 includes (and thus recess 206 is defined by) a frustoconical wall 206a that extends axially to a planar terminal wall 206b. Projection 208 is fixably coupled to the upper end 190a of battery 190. In particular, in this embodiment terminal wall 206b of is spot welded to the upper end 190a of battery 190.

Lower tab 200b does not include a projection 208 and recess 206 as described above for upper tab 200a and instead includes a cylindrical post 163 extending axially therefrom (see FIG. 3). As best shown in FIG. 3, cylindrical post 163 extends axially away from lower end 190b of battery 190 and through throughbore 142 when lower tab 200b is installed within cavity 102 as described above. As will be described in more detail below, post 163 can freely move axially within throughbore 142 as outer housing 101 and carrier 140 axially reciprocate relative to battery 190 during operations. As shown in FIG. 3, a distal end 163b of post 163 is engaged with the sensor element 182 of sensor assembly 180. Thus, as post 163 moves axially within throughbore 142, distal end 163b transfers forces and pressure to sensor element 182 so that element 182 begins to generate electrical signals that are indicative of the vibrations transferred to sensor 100 during operations as described in more detail below.

Referring again to FIGS. 3 and 4, each slot 207 within tabs 200 extends axially through the corresponding tab 200. In addition, each slot 207 spirals radially outward moving from a radially inner end proximal central projection to edges 201a, 201b. In this embodiment, four slots 207 are provided, each pair of circumferentially adjacent inner ends of slots 207 are angularly spaced 90° apart about axis 145, each pair of circumferentially adjacent outer ends of slots 207 are angularly spaced 90° apart about axis 145, and each slot 207 extends along a spiral angle measured about axis 145 between its ends of about 360°. The radially inner ends of slots 207 on upper tab 200a are radially adjacent projection 208, and the radially inner ends of slots 207 on lower tab 200b are radially adjacent post 163.

As previously described, tabs 200 provide electrical couplings between battery 190 and circuit board 195. In addition, tabs 200 function like flexures or biasing members for suspending battery 190 within pocket 144. Accordingly, tabs 200 may also be referred to as flexures or biasing members. In particular, tabs 200 are resilient flexible elements that flex and elastically deform in response to relative axial movement of outer housing 101 and carrier 140 relative to battery 190. In addition, tabs 200 radially bias battery 190 to a central or concentric position within pocket 144 radially spaced from carrier 140. In particular, the presence of spiral slots 207 enhances the flexibility of tab 200 in the region along which slots 207 are disposed, thereby allowing that region to flex in the axial direction (up and down) with relative ease. Spiral slots 207 also enhance the flexibility of each tab 200 in the radial direction. However, spiral slots 207 may generally resist some flexing of tabs 200 in the radial direction. Due to the relatively high degree of flexibility of tabs 200 in the axial direction, when an axial load is applied to tabs 200 by carrier 140 or battery 190, slots 207 generally allow free relative axial movement between central projection 208 and edges 201a, 201b on upper tab 200a and free relative axial movement between post 163 and edges 201a, 201b on lower tab 200b. However, due to the more limited flexibility in the radial direction, when a radial load is applied to tabs 200 by carrier 140 or battery 190, slots 207 may generally resist relative some (but not necessarily all) radial movement between the central projection 208 and edges 291a, 291b of upper tab 200a and between post 163 and edges 201a, 201b of lower tab 200b. Thus, tabs 200 bias battery 190 and carrier 140 back into substantial coaxial alignment with axes 105, 145 (but with the radial offset of battery 190 as previously described above).

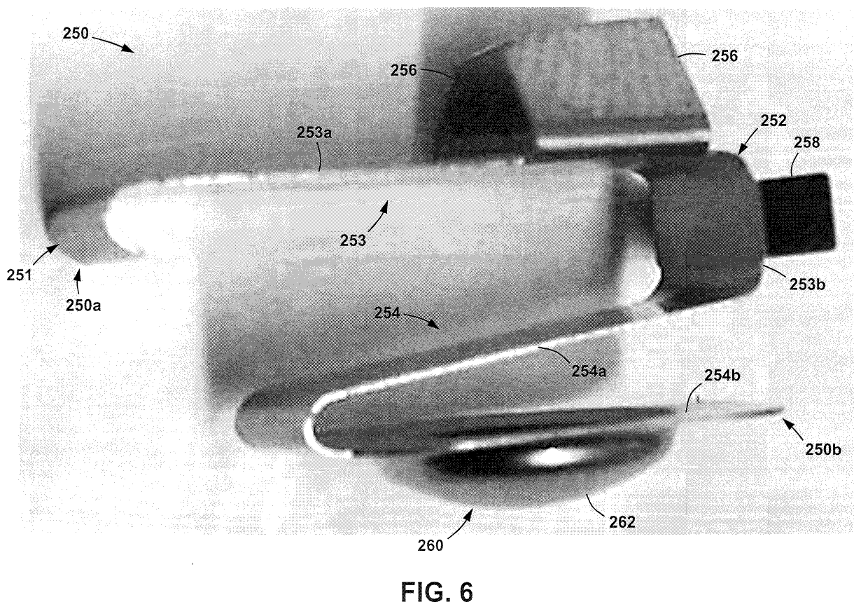

Referring now to FIGS. 3, 5, and 6, a biasing member 250 is installed within pocket 144 of carrier 140 and is engaged with upper tab 200a. As will be described in more detail below, basing member 250 facilitates the axial deflection of battery 190 and tabs 200 during operations, while generally further resisting radial deflection of battery 190 and tabs 200. However, biasing member 250 allow for radial deflection of battery 190 and tabs 200, in order avoid damage thereto when sufficiently large radially directed shocks are transferred to sensor 100. As best shown in FIG. 6, biasing member 250 includes a first end 250a, a second end 250b, and a body 252 extending between ends 250a, 250b.

Generally speaking, biasing member 250 is a flat spring (e.g., such as a leaf spring), and thus, body 252 is an elongate resilient member with one or more bends between ends 250a, 250b. In particular, body 252 includes a first or fixed portion 253 and a second or free portion 254. Fixed portion 253 extends from first end 250a, and free portion 254 extends from fixed portion 253 to second end 250b.

More particularly, fixed portion includes a connector 251 disposed at first end 250a, a first leg 253a extending from connector 251, and a second leg 253b extending from first leg 253a to free portion 254. In this embodiment, second leg 253b extends at approximately 90° to first leg 253a when no load is placed on biasing member 250. A first pair of connection tabs 256 extend outward from first leg 253a of fixed portion 253 and a second connection tab 258 extends outward from second leg 253b of fixed portion 253.

Free portion 254 includes a first leg 254a extending from second leg 253b of fixed portion 253, and a second leg 254b extending from first leg 254a to second end 250b. First leg 254a extends at an angle between 0 and 90°, such as, for example, between 0° and 45° relative to second leg 253b of fixed portion 253 when no load is placed on biasing member 250. Second leg 254b of free portion 254 extends at an angle between 0 and 45°, such as, for example, between 0 and 30° relative to first leg 254a when no load is placed on biasing member 250. In this embodiment, second leg 254a extends generally parallel to first leg 253a of fixed portion 253 when no load is placed on biasing member.

A projection is mounted to free portion 254 of biasing member 250, proximate second end 250b. In this embodiment, the projection comprises a convex engagement member 260 that includes a convex hemispherical surface 262. Convex engagement member 260 is coupled to second leg 254b of free portion 254, proximate second end 250b.

Biasing member 250, and in particular body 252, may be constructed out of any suitable elastically resilient material, such as, for example, a metal (e.g., steel, such as spring steel). In addition, body 252 may have a thickness that allows for suitable deflection of body 252 (e.g., particularly free portion 254) during operations, without being either too stiff or weak in light of the expected forces within sensor 100. In this embodiment, the thickness of body 252 may range from about 0.12 mm to about 0.27 mm. In particular, with one or more embodiments, the thickness of body 252 can be about 0.20 mm. When the thickness of body 252 is increased, the stiffness of body 252 is generally increased, while the flexibility of body 252 is generally decreased. When the thickness of body 252 is decreased, the stiffness of body 252 is generally decreased, while the flexibility of body 252 is generally increased. One or more embodiments configure the body 252 to be sufficiently stiff in the lateral direction of the seismic sensor, while being sufficiently flexible in the axial direction of the seismic sensor. In particular, with one or more embodiments, these conditions can be satisfied when the thickness of body 252 is about 0.2 mm; however, other values above and below the above-described range are contemplated herein for other embodiments. Further, body 252 may have a uniform (e.g., constant) or a non-uniform (e.g., variable) thickness between ends 250a, 250b. In this embodiment, the thickness of body 252 is generally uniform between ends 250a, 250b.

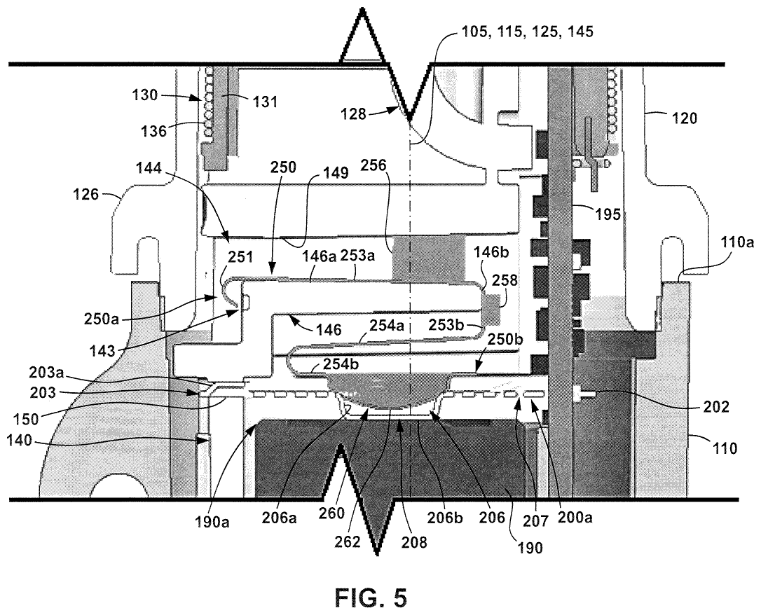

As shown in FIG. 5, fixed portion 253 is disposed about projection 146 in receptacle 144 such that both first and second legs 253a, 253b are engaged with projection 146. In particular, first leg 253a is engaged along a first surface 146a of projection 146, while second leg 253b is engaged with a second surface 146b of projection. First surface extends 146a generally radially with respect to axes 105, 145, and second surface 146b extends substantially orthogonally to first surface 146a (e.g., in this embodiment, second surface 146b extends generally axially with respect to axes 105, 145). In addition, the connector 251 is engaged with a recess 143 formed within projection 146 opposite second surface 146b, the first pair of connection tabs 256 engage with upper end surface 149 of pocket 144, and the second connection tab 258 engages with an inner wall of pocket 144. Thus, when fixed portion 253 of biasing member 250 is disposed about projection 146 within pocket 144 as shown in FIG. 5, fixed portion 253 is prevented (or at least restricted) from moving relative to projection 146.

Further, when biasing member 250 is engaged about projection 146 as described above, hemispherical surface 262 of convex engagement member 260 extends generally toward upper tab 200a. In particular, convex surface 262 is received within recess 206 such that hemispherical surface 262 engages with frustoconical surface 206a. The sliding engagement between hemispherical surface 262 and frustoconical surface 206a promotes alignment between convex engagement member 260, upper tab 200a, and battery 190 in a direction that is parallel to and radially offset from aligned axes 105, 145. Thus, the engagement between member 260 and recess 206 may further bias battery 190 toward a central position within pocket 144 in the radial direction with respect to aligned axes 105, 145.

When biasing member 250 is installed about projection 146 within pocket 144 as described above, body 252, including fixed portion 253 and free portion 254, may bend and flex between ends 250a, 250b. Specifically, in this embodiment, free portion 254 may elastically bend, flex, and deflect relative to fixed portion 253. Namely, first leg 254a of free portion 254 may bend or flex relative to second leg 253b of fixed portion 253. In addition, the legs 254a, 254b of free portion 254 may also elastically bend, flex, and deflect relative to one another during operations. As a result, during operations, convex engagement member 260 may be biased axially into recess 206 of upper tab 200a, and body 252 may bend and deform elastically to accommodate axial deflections of engagement member 260 (e.g., with respect to aligned axes 105, 145). In addition, the shape of biasing member 250 is such that radial deflections of convex engagement member 260 are largely resisted and potentially prevented. However, as will be described in more detail below, if large shocks are transmitted to sensor 100 in the radial direction (e.g., with respect to aligned axes 105, 145), battery 190 may be allowed to translate radially within receptacle 144 via sliding engagement between hemispherical surface 262 on convex engagement member 260 and frustoconical surface 206 of recess 206.

Referring now to FIGS. 3-5, during seismic surveys, a plurality of sensors 100 are coupled to the surface of the earth (e.g., in place of sensors 64, 66, 68 in system 50 shown in FIG. 1). Each sensor 100 may, for example, be attached to a spike which is pushed into the earth. Alternatively, the entire sensor 100 may be buried, or placed at depth in a borehole. Regardless of how sensors 100 are coupled to the earth, each sensor 100 can be positioned with axis 105 oriented in a generally vertical direction (e.g., aligned with the force of gravity).

The arrival of a compressional seismic wave causes outer housing 101 and the components fixably coupled thereto (e.g., spool assembly 130, carrier 140, circuit board 195, light guide 129, etc.) to move in a generally vertical direction. The inertia of the proof mass (which in this embodiment comprises battery 190 as previously described above) within outer housing 101 causes the proof mass to resist moving with the displacement of the outer housing 101 and carrier 140, and consequently the outer housing 101 and carrier 140 reciprocate axially relative to the proof mass, as permitted by tabs 200 and biasing member 250. This movement causes tabs 200 and free portion 254 (including engagement member 260) of biasing member 250 to flex or be deflected and the load of the proof mass to be taken up by the sensing element 182. The axial reciprocation of the outer housing 101 and carrier 140 relative to the proof mass generally continues as the compressional seismic wave passes across sensor 100.

During the axial reciprocations of the outer housing 101 and carrier 140 relative to the proof mass, the sensor element 182 is cyclically deflected by post 163. As previously described, when mechanical stress is applied to sensor element 182 due to deformation or deflection by post 163, the piezoelectric ceramic material generates an electrical potential (piezoelectric effect). The electrical potential is connected to circuit board 195 via wires (or other suitable conductive paths as previously described), where it is detected, and may be sampled and stored in memory as a measure of the amplitude of the seismic vibration. Thus, during operations, the sensor element 182 generates a signal that is indicative of the vertical movement of the outer housing 101 relative to the proof mass (e.g., battery 190) as induced by the seismic vibration. The data stored in memory on the circuit board 195 can be communicated to an external device for further consideration and analysis (e.g., via light guide 228, and top 221 as previously described).

As previously described, tabs 200 and biasing member 250 allow generally free relative axial movement of the proof mass relative to the outer housing 101. In the resting position, post 163 engages sensor element 180, and further, sensor element 180 supports the majority or substantially all of the weight of the proof mass. The axial reciprocation of the outer housing 101 and carrier 140 relative to the proof mass subjects sensor element 180 to increasing and decreasing degrees of stress. The variations in the stress experienced by sensor element is used to detect and measure the seismic waves as previously described above. However, it should be appreciated that the ceramic material of the sensor element 182 may be damaged by excessive stress. Accordingly, the maximum axial movement of outer housing 101 relative to the proof mass is limited to protect the sensor element 180 and prevent it from being overly stressed. In this embodiment, the maximum axial movement of outer housing 101 to the proof mass is controlled and limited by carrier 140—tabs 200 and free end 254 of biasing member 250 can deflect axially upward until free end 254 of biasing member 250 engages with projection 146 and tabs 200 and biasing member 250 can deflect axially downward until lower tab 200b axially engages carrier 140 at lower end 147 of pocket 144.

As previously described above, axially directed movement of outer housing 101 and carrier 140 relative to the proof mass are used to generate signals indicative of the sensed seismic vibrations (e.g., via sensor element 182). Conversely, radially directed movement of outer housing 101 and carrier 140 relative to the proof mass can cause undesirable noise in the output signal from sensor element 182. As a result, tabs 200 and biasing member 250 generally bias battery 190 to a centered position within pocket 144 of carrier 140 so as to generally restrain movement of the proof mass (which again comprises battery 190) relative to housing 101 and carrier 140 in the radial direction as previously described above. Consequently, the movement of the outer housing 101 and carrier 140 relative to the battery 190 is predominately in the axial direction during a seismic survey.

However, during seismic survey operations, relatively large radially directed impulses or shocks may be transferred to sensor 100. Sources of such radially directed shocks include, for example, ambient sources. In some embodiments, ambient sources can include operating vehicles, operating equipment, ground roll, artificial sources that impart impulses/shocks, natural sources that impart impulses/shocks, and/or a combination thereof. If all radial relative movement between battery 190 and housing 101 (and carrier 140) were prevented during these operations, these relatively large shocks may be transferred to and thus cause damage to various components within housing 101 (e.g., circuitry 195, battery 190, carrier 140, etc.). To prevent such damage from occurring, convex engagement member 260 may be shifted radially within recess 260 of upper tab 200a when a sufficiently large radially directed force is transferred thereto through housing 101 and carrier 140. This movement of biasing member 250 relative to upper tab 200a and battery 190 may allow some (or all) of the radially directed shock to be dissipated, thereby sparing the other components within sensor 100 from damage.

With particular reference to FIG. 5, during the above described seismic survey operations, engagement member 260 of biasing member 250 is typically seated within recess 206 of upper tab 200a such that hemispherical surface 262 is engaged with frustoconical surface 206a. The friction between surfaces 262, 206a (which may be enhanced by the axially directed biasing forces applied from biasing member 250 and tabs 200) generally prevents relative radial movement between convex engagement member 260 and recess 206, so that noise within the resulting output from sensor element 182 is reduced. However, if a sufficiently large radially directed shock, such as, for example, a radially directed shock, force, or impulse that is above a threshold, is transferred to engagement member 260 or recess 206 (e.g., radial with respect to aligned axes 105, 145), then engagement member 260 may be shifted radially within recess 206. As a result, hemispherical surface 262 may slidingly engage with frustoconical surface 206a (and even potentially terminal wall 206b) to allow movement of housing 101 and carrier 140 relative to the proof mass. During this process, engagement member 260 is not totally or completely disengaged from recess 206 due to the limited radial gap between battery 190 and cylindrical wall 148 of pocket 140. As a result, once the radially directed force is removed or dissipated, engagement member 260 is biased back to a radially centered position within recess 206 (e.g., such as the position shown in FIG. 5) by, for example, sliding engagement of hemispherical surface 262 and frustoconical surface 206a and the axial bias applied by biasing member 250 and tabs 200. Thus, in this embodiment, the sliding engagement between convex engagement member 260 of biasing member 250 and recess 206 of upper tab 200a allows for relative radial movement between upper tab 200a and battery 190 when a relatively large radially directed impulse or shock is transferred to sensor 100. As a result, the force of the radial shock is dissipated (e.g., at least partially) by the relative movement of engagement member 260 within recess 206, and damage to other connected components within cavity 102 of housing 101 (e.g., battery 190, tab 200a, carrier 140) is prevented.

As described above, embodiments disclosed herein include seismic sensors including one or more biasing members that generally allow relative movement between the internal proof mass and outer housing within desired longitudinal axis, but also restrict the relative moment of the proof mass and housing in a lateral direction (e.g., sensor 100, biasing members 250, 200, etc.). In addition, the one or more biasing members may allow some relative movement of the proof mass and housing when a sufficiently large, off-axis (e.g., lateral or radial) shock or impulse is transferred to the seismic sensor. Thus, through use of the seismic sensors disclosed herein, off-axis vibrations may be reduced during normal seismic survey operations so that the resulting seismic measurements may have less noise; however, damage to internal components of the seismic sensor as a result of large off-axis impulses may also be reduced or eliminated entirely.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A seismic sensor, comprising:
an outer housing having a central axis, an upper end, a lower end, and an inner cavity;
a proof mass moveably disposed in the inner cavity, wherein the outer housing is configured to move axially relative to the proof mass;
a first biasing member disposed in the inner cavity and axially positioned between the proof mass and the upper end of the outer housing, wherein the first biasing member is configured to flex in response to axial movement of the outer housing relative to the proof mass, and wherein the first biasing member comprises a disc including a plurality of circumferentially-spaced slots extending axially therethrough and an axially extending recess;
a second biasing member disposed in the inner cavity and axially positioned between the first biasing member and the upper end of the outer housing, wherein the second biasing member includes a projection that is configured to engage with the recess of the first biasing member; and
a sensor element disposed in the inner cavity and axially positioned between the proof mass and the lower end of the outer housing, wherein the sensor element comprises a piezoelectric material configured to deflect and generate a potential in response to the axial movement of the outer housing relative to the proof mass and the flexing of the first biasing member and the second biasing member.

2. The seismic sensor of claim 1, wherein the projection comprises a convex engagement member, and wherein the second biasing member is configured to axially bias the convex engagement member into the recess of the first biasing member.

3. The seismic sensor of claim 2, wherein the convex engagement member comprises a hemispherical surface, wherein the recess of the first biasing member comprises frustoconical surface, and wherein the hemispherical surface is engaged with the frustoconical surface when the convex engagement member is received within the recess.

4. The seismic sensor of claim 2, wherein the second biasing member is configured to resist radial deflection of the convex engagement member.

5. The seismic sensor of claim 2, further comprising a third biasing member disposed in the inner cavity and axially positioned between the proof mass and the sensor element, wherein the third biasing member is configured to flex in response to axial movement of the outer housing relative to the proof mass, wherein the third biasing member comprises a disc including a plurality of circumferentially-spaced slots extending axially therethrough.

6. The seismic sensor of claim 5, wherein the plurality of circumferentially-spaced slots of the first biasing member spiral radially outwards from a center of the first biasing member, and wherein the plurality of circumferentially-spaced slots of the third biasing member spiral radially outward from a center of the third biasing member.

7. The seismic sensor of claim 5, further comprising a carrier fixably coupled to the outer housing and disposed within the inner cavity, wherein the first biasing member, the second biasing member, and the third biasing member are fixably coupled to the carrier.

8. The seismic sensor of claim 7, wherein the second biasing member comprises a flat spring comprising:
a first end and a second end; and
a body extending between the first end and the second end;
wherein the body comprises a fixed portion extending from the first end and fixably coupled to the carrier, and a free portion extending from the fixed portion to the second end; and
wherein the convex engagement member is coupled to the free portion.

9. The seismic sensor of claim 8, wherein the free portion of the body of the second biasing member is configured to elastically bend when the convex engagement member is axially deflected.

10. A seismic sensor, comprising:
an outer housing having a central axis, a first end, a second end opposite the first end, and an inner cavity;
a proof mass moveably disposed in the inner cavity, wherein the proof mass comprises a power supply;
a disc-shaped sensor element disposed in the inner cavity and positioned axially between the proof mass and the second end, wherein the sensor element is configured to detect the movement of the outer housing relative to the proof mass;
electronic circuitry coupled to the sensor element;
a first resilient disc disposed in the inner cavity and axially positioned between the first end of the outer housing and the proof mass;
a second resilient disc disposed in the inner cavity and axially positioned between the proof mass and the sensor element;
wherein the first resilient disc and the second resilient disc each comprise a central region coupled to the proof mass and a radially outer periphery fixably coupled to the outer housing, wherein the first resilient disc and the second resilient disc each include a plurality of circumferentially-spaced slots extending axially therethrough, and wherein the first resilient disc includes an axially extending recess; and
a biasing member disposed in the inner cavity and axially positioned between the first resilient disc and the first end of the outer housing.

11. The seismic sensor of claim 10, further comprising a carrier fixably disposed within the inner cavity of the outer housing, wherein the first resilient disc, the second resilient disc, and the biasing member are fixably coupled to the carrier.

12. The seismic sensor of claim 11, wherein the biasing member comprises a flat spring comprising:
a first end and a second end; and
a body extending between the first end and the second end;
wherein the body comprises a fixed portion extending from the first end and fixably coupled to the carrier, and a free portion extending from the fixed portion to the second end; and
wherein the projection is coupled to the free portion.

13. The seismic sensor of claim 12, wherein the free portion of the body of the biasing member is configured to elastically bend when the projection is deflected axially.

14. The seismic sensor of claim 10, wherein the projection comprises a hemispherical surface, wherein the recess of the first biasing member comprises frustoconical surface, and wherein the hemispherical surface is engaged with the frustoconical surface when the projection is received within the recess.

15. The seismic sensor of claim 14, wherein the plurality of circumferentially-spaced slots of the first resilient disc spiral radially outwards from a center of the first resilient disc, and wherein the plurality of circumferentially-spaced slots of the second resilient disc spiral radially outward from a center of the second resilient disc.

16. The seismic sensor of claim 10, wherein the biasing member includes a projection that is received within the recess of the first resilient disc, and wherein the biasing member is configured to allow axial deflection of the projection and to resist radial deflection of the projection.

17. A method for detecting seismic waves passing through a subterranean formation, the method comprising:
(a) coupling a seismic survey apparatus to the ground above the subterranean formation, wherein the seismic survey apparatus comprises:
an outer housing having a longitudinal axis, an upper end, a lower end, and an inner cavity;
a proof mass moveably disposed in the inner cavity;
a sensor element disposed in the inner cavity and axially positioned between the proof mass and the lower end of the outer housing;
a first resilient disc disposed in the inner cavity and axially positioned between the first end of the outer housing and the proof mass;
a second resilient disc disposed in the inner cavity and axially positioned between the proof mass and the sensor element; and
a biasing member disposed in the inner cavity and axially positioned between the first resilient disc and the upper end of the outer housing, wherein the biasing member includes a projection that is received within an axially extending recess of the first resilient disc;
(b) orienting the seismic survey apparatus with the longitudinal axis of the housing in a vertical orientation;
(c) moving the outer housing vertically relative to the proof mass in response to seismic waves;
(d) axially flexing the first resilient disc, the second resilient disc, and the biasing member in response to (c);
(e) axially deflecting the sensor element during (c) and (d); and
(f) generating a signal with the sensor element indicative of the vertical movement of the outer housing relative to the proof mass during (c) in response to (e).

18. The method of claim 17, further comprising:
(g) radially deflecting the outer housing radially relative to the proof mass in response to seismic waves; and
(h) radially sliding the projection within the recess during (g).

19. The method of claim 18, wherein the biasing member comprises a flat spring comprising:
a first end and a second end; and
a body extending between the first end and the second end;
wherein the body comprises a fixed portion extending from the first end and fixably coupled to the carrier, and a free portion extending from the fixed portion to the second end; and
wherein the projection is coupled to the free portion; and
wherein the method further comprises elastically bending the free portion of the body and axially deflecting the projection during (d).

20. The method of claim 19, wherein the projection comprises a hemispherical surface and the recess of the first resilient disc comprises a frustoconical surface, and wherein (h) comprises slidingly engaging the hemispherical surface with the frustoconical surface during (g).
